(19) United States
(12) Patent Application Publication
(10) Pub. No.: US 2017/0213044 A1
(43) Pub. Date: Jul. 27, 2017

(54) Privilege Log Generation Method and Apparatus

(71) Applicant: Lighthouse Document Technologies, Inc. (d/b/a Lighthouse eDiscovery), Seattle, WA (US)

(72) Inventors: John Charles Olson, Seattle, WA (US); Christopher Byron Dahl, Seattle, WA (US)

(21) Appl. No.: 15/005,699

(22) Filed: Jan. 25, 2016

(51) Int. Cl. G06F 21/62; G06F 17/30

(52) U.S. Cl. CPC G06F 21/6209; G06F 17/30569; G06F 17/30011

(57) ABSTRACT

Apparatuses, methods and storage medium associated with electronic production of documents for a discovery request are disclosed herein. In embodiments, an apparatus for producing document for a discovery request may comprise a privilege log generator to generate a privilege log for a plurality of electronic documents to be produced for a discovery request, wherein at least a subset of the plurality of electronic documents are at least partially privilege protected. Further, the privilege log generator may include a name-email normalization function to provide assistance in normalization of names or email addresses contained in the electronic documents for the privilege log. Other embodiments may be disclosed or claimed.

### TECHNICAL FIELD

The present disclosure relates to the field of electronic document processing technology, in particular, to apparatuses, methods and storage medium associated with generation of a privilege log for a plurality of documents to be produced for a discovery request, e.g., in litigation, arbitration, or investigation.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

With advances in computing and networking technologies, increasingly businesses are conducted with electronic communications and documents, such as electronic mails, electronic word documents, and so forth. Thus, compliance with a discovery request of litigation, arbitration or investigation proceeding often involves the production of tens of thousands, if not hundred of thousands, of pages of electronic communications and documents. For manageability, the production is typically made electronically. Various e-discovery applications exist today to assist in management of the discovery process, e.g., Relativity from kCura of Chicago, Ill.

Frequently, a significant subset of the electronic communications and documents are at least partially privilege protected. Accordingly, a privilege log tracking the subset of electronic communications and documents subject to full or partial privilege protection is often prepared. Today, the process of preparing the privilege log is mostly manual.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of an example computing environment having the privilege log generator of the present disclosure, in accordance with various embodiments.

FIG. 2 illustrates an overview of the auto privilege description generation aspect of the privilege log generator, in accordance with various embodiments.

FIG. 3 illustrates an example user interface of the auto description aspect of the privilege log generator, in accordance with various embodiments.

FIG. 4 illustrates an example operation flow or process for generating a standardized privilege description entry for a document for a privilege log, in accordance with various embodiments.

FIG. 5 illustrates an overview of the name-email normalization aspect of the privilege log generator, in accordance with various embodiments.

FIGS. 6a-6d collectively illustrate an example user interface of the name-email normalization aspect of the privilege log generator, in accordance with various embodiments.

FIG. 7 illustrates an example operation flow or process for normalizing names or emails in documents to be produced for a discovery request, in accordance with various embodiments.

FIGS. 8a-8e collectively illustrate various example data objects suitable for use to implement the name-email normalization function FIG. 1 (or FIG. 5) or practice the process of name-email normalization of FIG. 7.

FIGS. 9a-9c collectively illustrate example pseudo code for the logic flow of the email field normalization operations of FIG. 7.

FIGS. 10a-10d collectively illustrate example pseudo code for the logic flow of the document thread participant normalization operations of FIG. 7.

FIGS. 11a-11c collectively illustrate example pseudo code for the logic flow of the import list normalization operations of FIG. 7.

FIG. 12 illustrates an example computer system, suitable for practicing the present disclosure, in accordance with various embodiments.

FIG. 13 illustrates an example computer-readable storage medium with instructions configured to practice aspects of the present disclosure, in accordance with various embodiments.

### DETAILED DESCRIPTION

Apparatuses, methods and storage medium associated with electronic production of documents for a discovery request. In embodiments, an apparatus for producing document for a discovery request may comprise one or more processors; and a privilege log generator to be operated by the one or more processors to generate a privilege log for a plurality of electronic documents to be produced for a discovery request, wherein at least a subset of the plurality of electronic documents are at least partially privilege protected. Further, the privilege log generator may include a name-email normalization function to provide assistance in normalization of names or email addresses contained in the electronic documents for the privilege log. Still further, the privilege log generator may include an auto privilege description generation function to automatically generate a standardized description for an entry in the privilege log.

In the description to follow, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

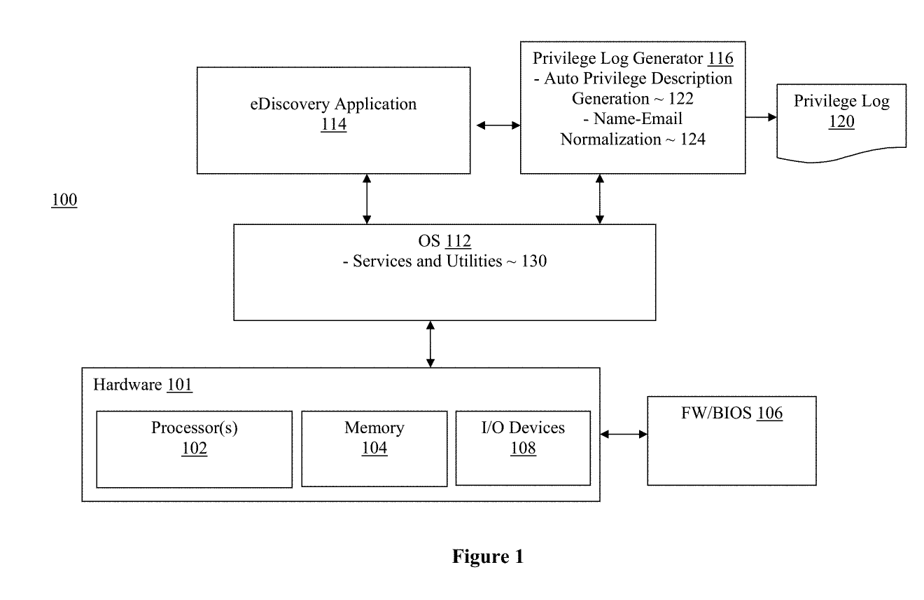

Referring now to FIG. 1, wherein a computing environment having the privilege log generator of the present disclosure, according to various embodiments, is shown. As illustrated, in embodiments, computing environment 100 may include hardware 101, firmware (FW)/basic input/output services (BIOS) 106, OS 112 and electronic discovery (eDiscovery) application 114, operatively coupled with each other as shown. Further, computing environment 100 may include privilege log generator 116 of the present disclosure, coupled with eDiscovery application 114 to assist in the generation of privilege log 120, e.g., as part of document production to comply with a discovery request of litigation/arbitration/investigation.

eDiscovery application 114 may be any one of a number of discovery management applications known in the art, e.g., Relativity, as mentioned earlier. eDiscovery application 114 may include an application programming interface (API) or web services for privilege log generator 116 to interact with eDiscovery application 114, e.g., to retrieve document objects from eDiscovery application 114.

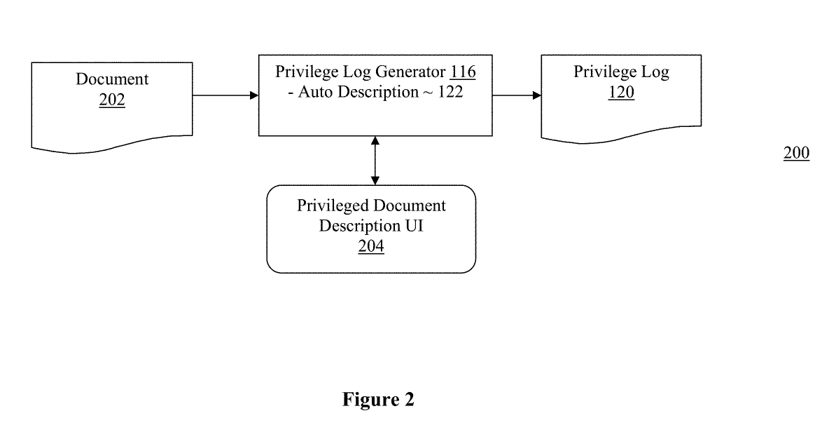

For the illustrated embodiments, privilege log generator 116 may include name-email normalization function 124 to provide assistance in normalization of names or email addresses contained in the electronic documents for privilege log 120. The normalization process ensures each email address/author name is mapped to one name. However, each name may have multiple email addresses. For example, Margaret Smith with email address msmith@yahoo.com, and Peggy Smith with the same email address, would be normalized to either Margaret or Peggy Smith for the msmith@yahoo.com email address. Whereas, Margaret Smith may have msmith@yahoo.com or psmith@gmail.com. In some embodiments, privilege log generator 116 may further include auto privilege description generation function 122 to semi-automatically generate a standardized description for each entry in privilege log 120. These and other aspects related to privilege log generation will be further described below with references to FIGS. 2-7, after the description of FIG. 1.

Still referring to FIG. 1, hardware 101 may include one or more multi-core processors 102, each with single or multiple cores of diverse capabilities. Single or multi-core processors 102 may be any one of a number of single or multi-core processors known in the art. In embodiments, hardware 101 may further include memory 104, I/O devices 108, or other elements (not shown). Memory 104 may be any known volatile or non-volatile memory in the art, suitable for storing data. Memory 104 may include a hierarchy of cache memory and system memory. Both the cache and system memory may be respectively organized into cache pages and memory pages. Examples of I/O devices 108 may include communication or networking interfaces, such as Ethernet, WiFi, 3G/4G, Bluetooth®, Near Field Communication, Universal Serial Bus (USB) and so forth, storage devices, such as solid state, magnetic and/or optical drives, input devices, such as keyboard, mouse, touch sensitive screen, and so forth, and output devices, such as, display devices, printers, and so forth.

FW/BIOS 106 may be any one of a number FW/BIOS known in the art. OS 112 may include a number of services and utilities 130. Services and utilities 130 may include services/utilities, such as memory management, input/output (I/O) devices allocation, and so forth. OS 112 may likewise be any one of a number of OS known in the art, e.g., the Windows OS from Microsoft® Corporation.

Before describing privilege log generator 116 further, it should be noted, while for ease of understanding, privilege log generator 116 is illustrated as a component separate from eDiscovery application 114, however the illustration is not to be read as limiting on the present disclosure. It is anticipated, in embodiments, privilege log generator 116 may be integrally implemented as part of eDiscovery application 114. Whether separately or integrally implemented, privilege log generator 116 and eDiscovery application 114 (or the rest of eDiscovery application 114) may be co-located in the same computing environment (as shown in FIG. 1), or distributed across different computing environments, e.g., on different virtual machines, or on different computing servers.

Referring now to FIG. 2, wherein an overview 200 of auto privilege description generation function 122 of privilege log generator 116, in accordance with various embodiments, is shown. As illustrated, for each document 202 to be produced that is subject to at least partial privilege protection, such as email, or electronic word document, auto privilege description generation function 122 may be configured to present or display a privileged document description user interface (UI) 204 having a plurality of input-fields to collect inputs for a plurality of portions of the standardized description for the description entry for privileged document 202 in privilege log 120. In response to the inputs, auto privilege description generation function 122 may automatically generate the standardized description for the description entry for privileged document 202 in privilege log 120, using the inputs collected. Resultantly, all description entries for privileged documents 202 in privilege log 120 may be standardized, and thereby, improve their descriptiveness.

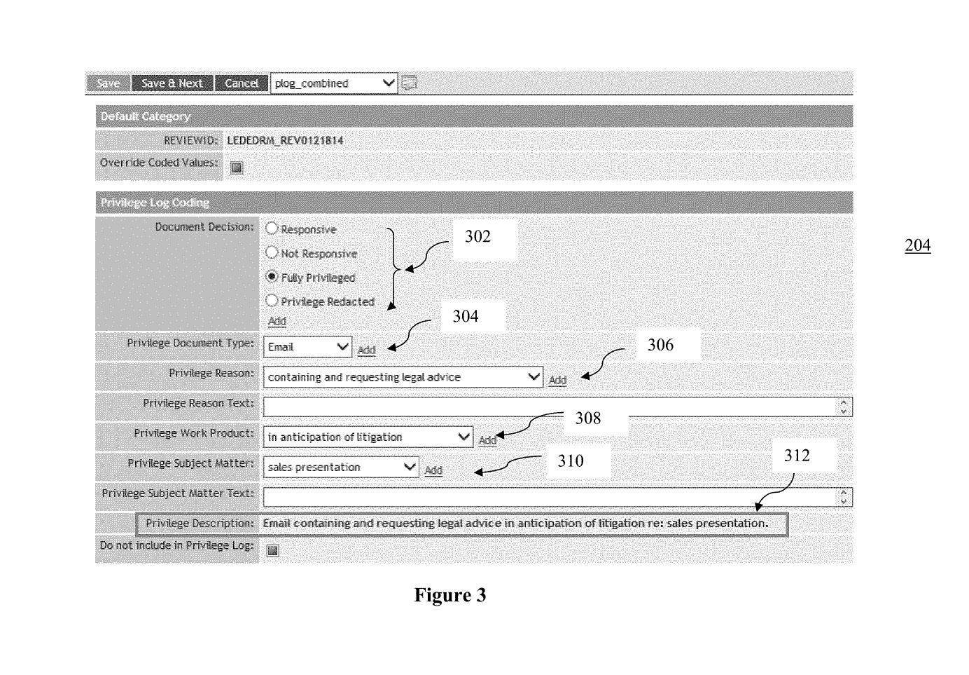

FIG. 3 illustrates an example privileged document description UI 204 of auto privilege description generation function 122, in accordance with various embodiments. As shown, for the embodiments, privileged document description UI 204 may include area 302 having a number of radio buttons to designate whether document 202 is fully privileged or privilege redacted. Privileged document description UI 204 may further include area 304 having a drop list of document types to designate a document type for document 202, such as, whether document 202 is an email, an electronic word document, and so forth.

Still further, privileged document description UI 204 may include area 306 having a drop list of privilege reasons to designate a privilege reason for document 202. Examples of privilege reason may include, but are not limited to, “containing and requesting legal advice,” “requesting legal advice and containing legal advice,” etc. Privileged document description UI 204 may include area 308 having a drop list of privilege work products to designate a privilege work product for document 202. Examples of privilege work product may include, but are not limited to, “in anticipation of litigation,” “prepared in anticipation of litigation”, etc. Privileged document description UI 204 may include area 310 having a drop list of privilege subject matters to designate a privilege subject matter for document 202. Examples of privilege subject matter may include, but are not limited to, “sales presentation,” “contract negotiation,” “acme litigation,” “customer information,” “draft marketing materials,” etc.

As shown, for the embodiments, on receipt of inputs for these mandatory input fields, auto privilege description generation function 122 would generate the standardized privilege description entry for document 202 for privilege log 120 by concatenating the inputs for privilege document type 302, privilege reason 306, privilege work product 308, and privilege subject matter 310. For the example inputs, the standardized privilege description entry for document 202 for privilege log 120 would be “Email containing and requesting legal advice in anticipation of litigation re: sales presentation.” In embodiments, the concatenation may be in accordance with a predetermined order. In embodiments, when text field gets associated with the document field like for example “Privilege Subject Matter” and “Privilege Subject Matter Text” exists, text field may take precedence based on not null value.

In embodiments, the selections available for one or more of input fields 302-310 may be configurable by a system administrator. In embodiments, privileged document description UI 204 may have more or less input fields 302-310.

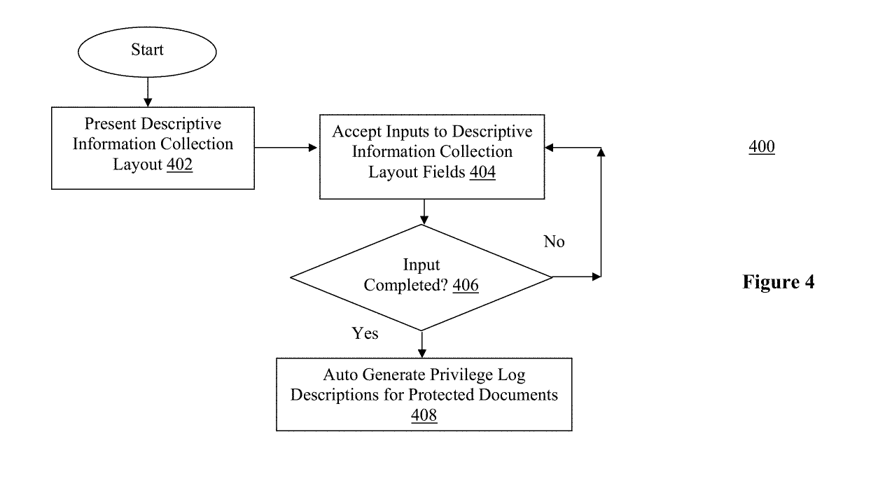

FIG. 4 illustrates an example operation flow or process 400 for generating a standardized privilege description entry for a document for a privilege log, in accordance with various embodiments. As shown, operation flow or process 400 may include operations performed at blocks 402-408. Process 400 for generating a standardized privilege description entry for a document for a privilege log may be performed e.g., by auto privilege description generation function 122 of privilege log generator 116.

As shown, process 400 may start at block 402. At block 402, a descriptive information collection layout having the input fields of the mandatory description portions may be presented. At block 404, inputs to the input fields of the mandatory description portions may be collected. At block 406, a decision may be made as to whether all inputs to all input fields of the mandatory description portions have been collected. If inputs to all input fields of the mandatory description portions have not been collected, process 400 may return to block 404, and continues therefrom as earlier described.

Eventually, when inputs to all input fields of the mandatory description portions have been collected, process 400 may proceed to block 408. At block 408, a standardized privilege description entry for the document for the privilege log may be generated, e.g., by concatenating the inputs to the input fields of the mandatory description portions. As described earlier, the concatenation may be in accordance with a predetermined order.

In alternate embodiments, one or more of the description portions may be non-mandatory. For these embodiments, a standardized privilege description entry for the document for the privilege log may be generated, e.g., by concatenating the inputs to the input fields of the mandatory portions and non-mandatory portions whose inputs are not null, when inputs to input fields of the mandatory description portions have been collected.

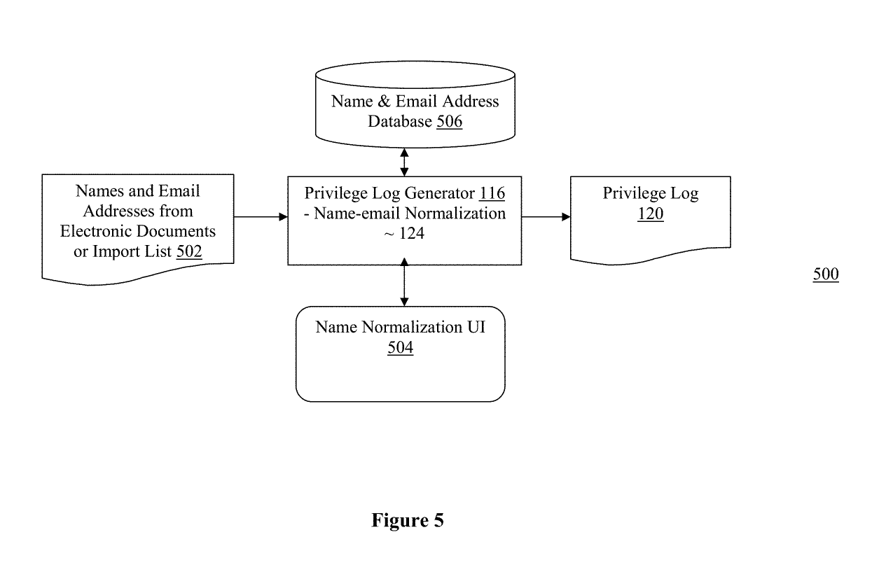

FIG. 5 illustrates an overview 500 of the name-email normalization function 124 of the privilege log generator 116, in accordance with various embodiments. As illustrated, for normalization of names and email addresses 502 extracted from email or electronic word documents or imported, name-email normalization function 124 may be configured to present or display name normalization user interface (UI) 504 for conflict resolution and management of the pre-normalized and post-normalized data. In embodiments, name-email normalization function 124 may maintain normalized names and/or email addresses in database 506, and presentation or display of name normalization user interface (UI) 504 for conflict resolution and management of the pre-normalized and post-normalized data, may be performed referencing the normalized names and/or addresses stored in database 506. Resultantly, all names and email addresses for privileged documents 202 in privilege log 120 may be normalized, i.e., one name for each email address, but each name may have multiple email addresses, and thereby, improve clarity/usability of privilege log 120.

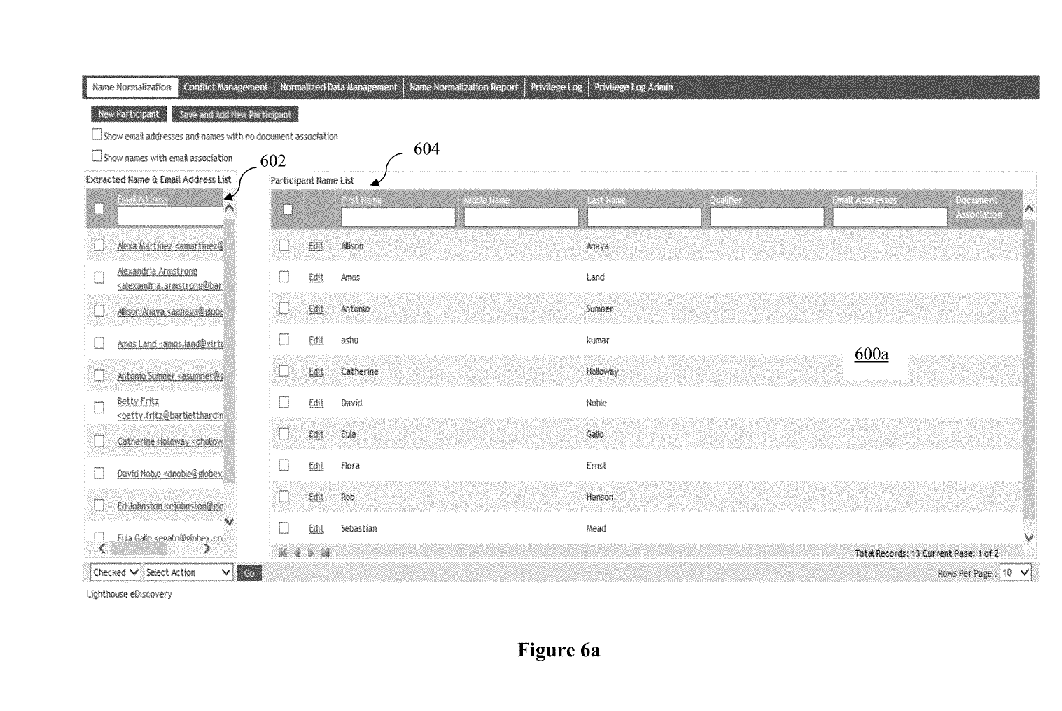

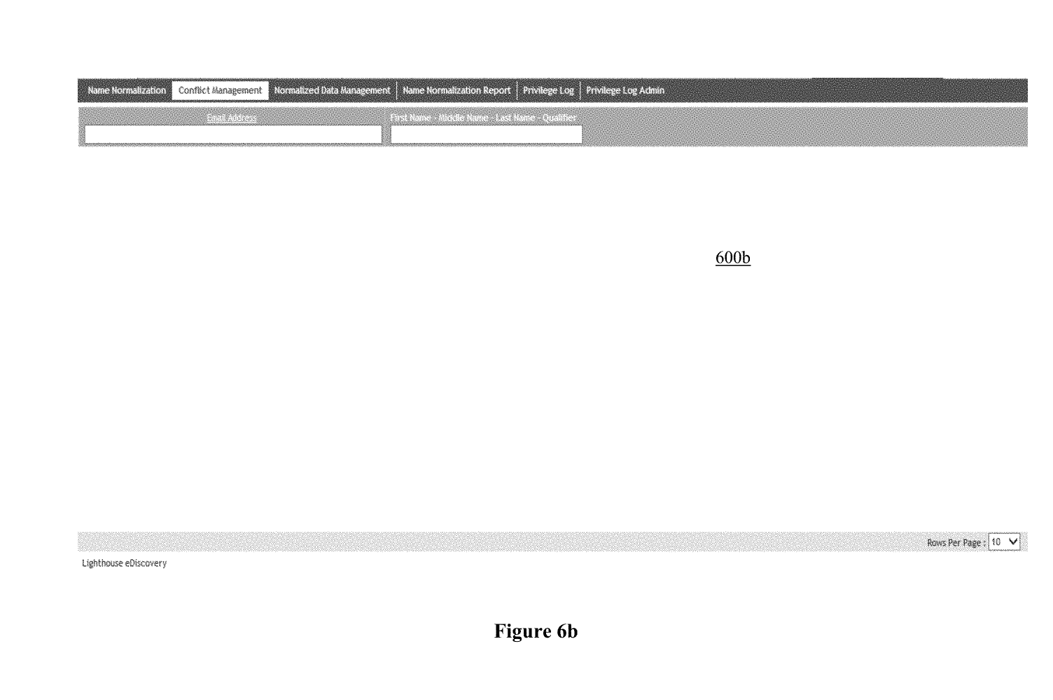

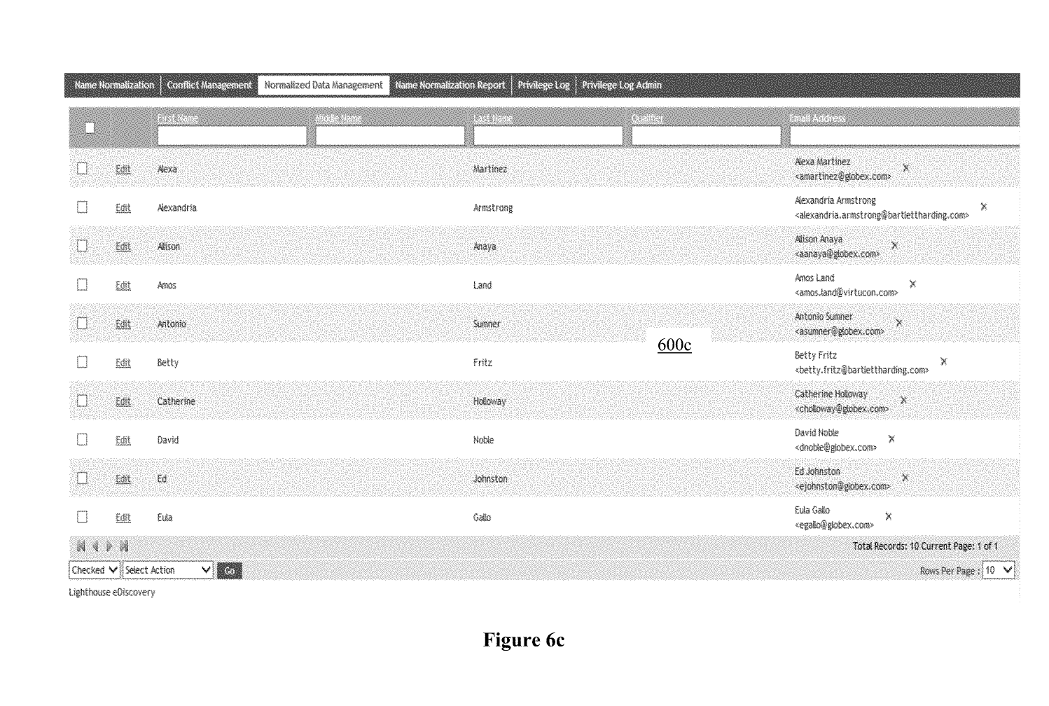

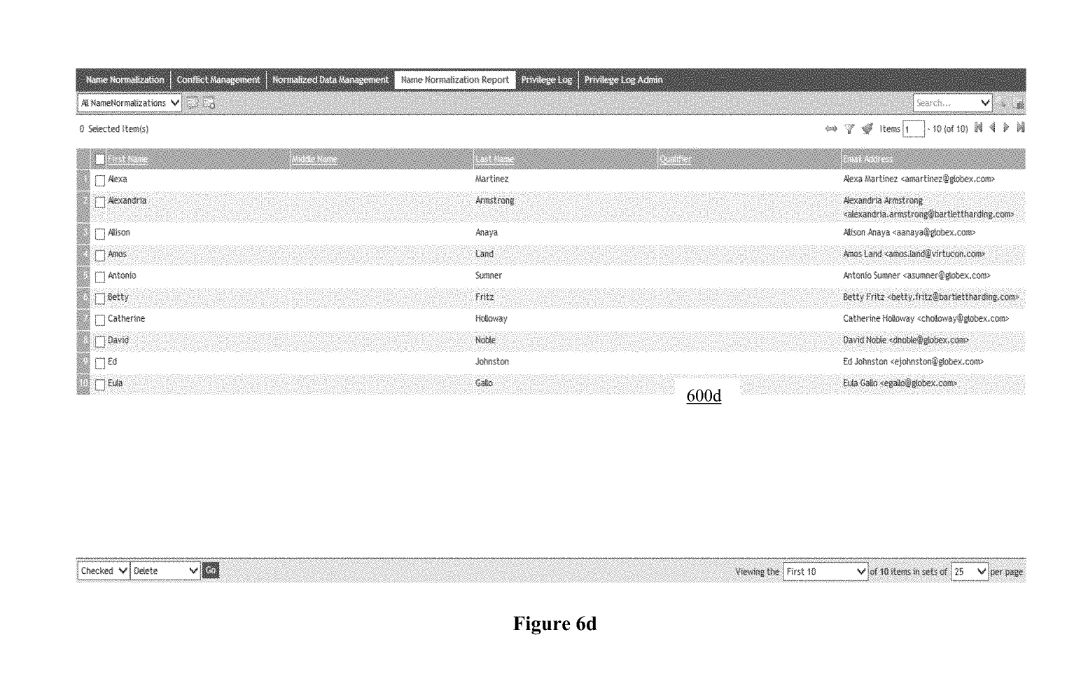

FIGS. 6a-6d collectively illustrate an example UI of name-email normalization function 124 of the privilege log generator 116, in accordance with various embodiments. As shown, UI of name-email normalization function 124 may include four tabs, name normalization tab 600a, conflict management tab 600b, normalized data management tab 600c, and name normalization report tab 600d. Name normalization tab 600a may be used to display the names and emails extracted from documents 202 subject to at least partial privilege protection, and names of participants. Participant is the name (first name, middle name, last name and qualifier) which is to be associated with extracted email address/name. The associated user Interface may display the data which is to be normalized. User either can leverage predict name function or manually enters the participant name and then associate with the extracted content. Conflict management tab 600b may be used to resolve name or email address conflicts, e.g., an email address having more than one name mapping. A user may use conflict management tab 600b to indicate the correct mapping between a name and an email address. Normalized data management tab 600c may be used to manage post normalized data, e.g., to review and to remove selected ones of the mapped associations or deletion of selected ones of the complete associations. Name normalization report tab 600d may be used to display the read-only normalized name and email address mappings report.

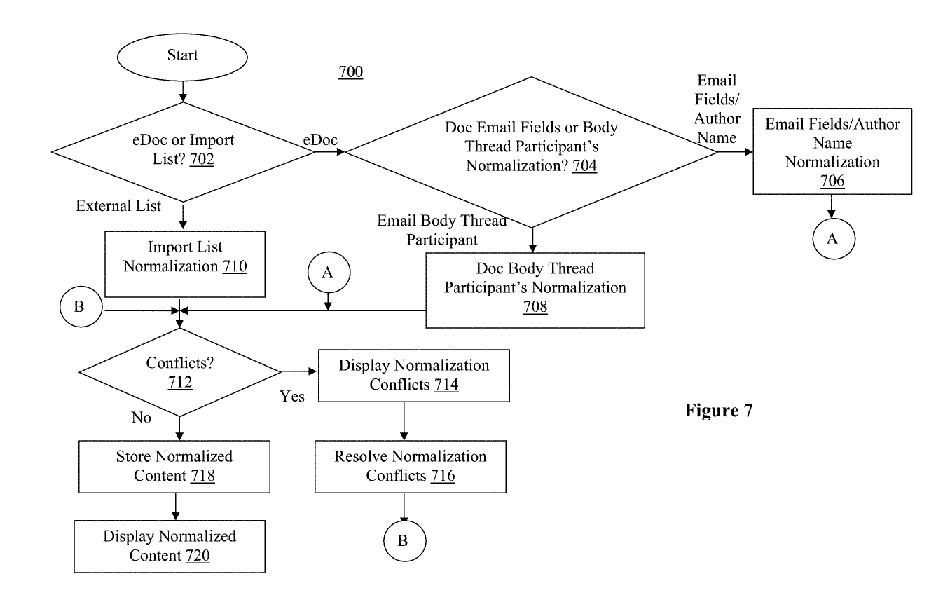

FIG. 7 illustrates an example operation flow or process 700 for normalizing names or emails in documents to be produced for a discovery request, in accordance with various embodiments. As shown, for the embodiments, process 700 may include operations performed at blocks 702-720. The operations may be performed e.g., by name-email normalization function 124 of privilege log generator 116.

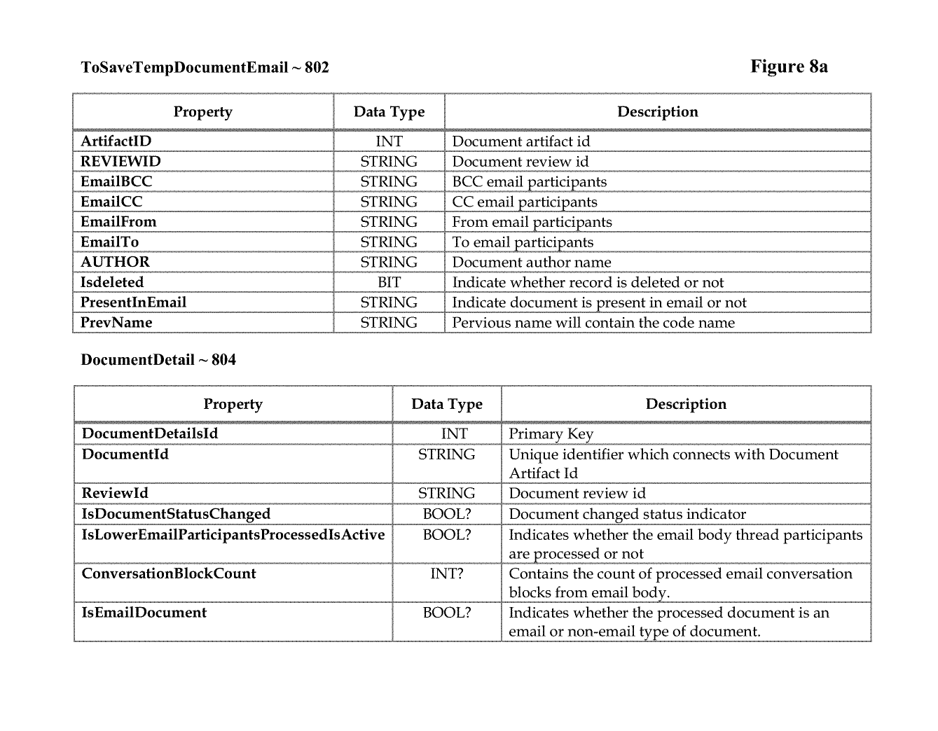

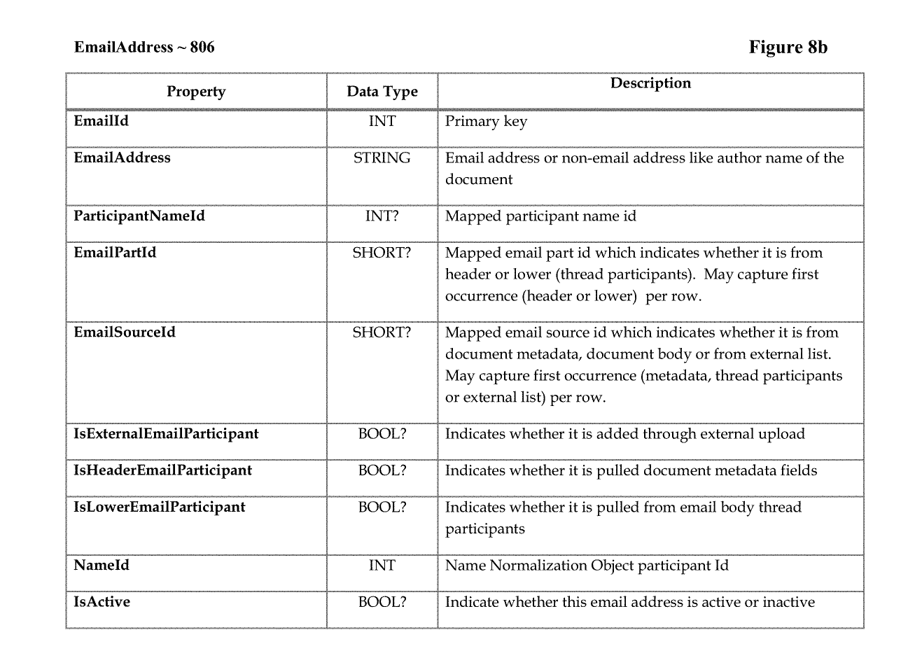

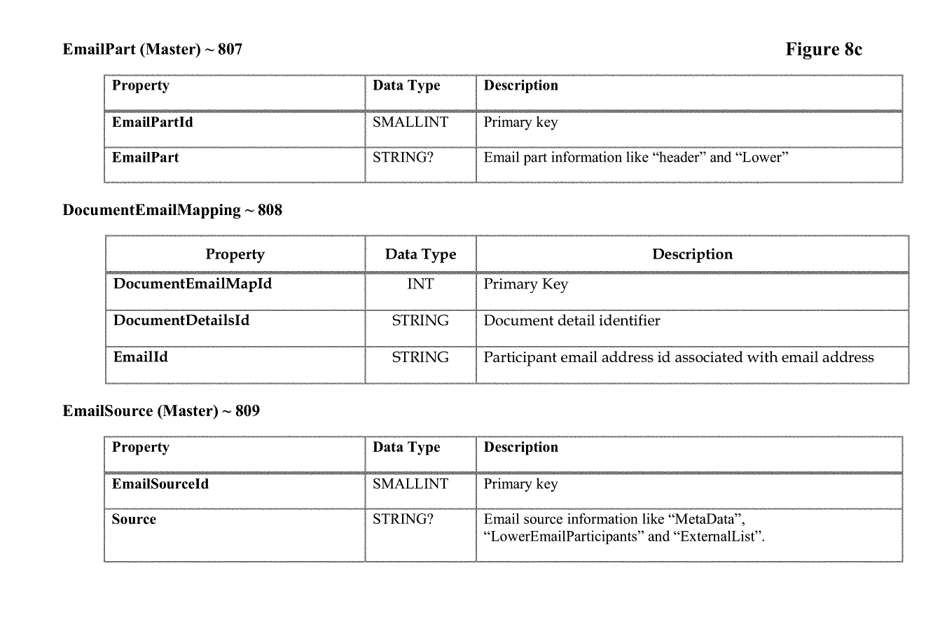

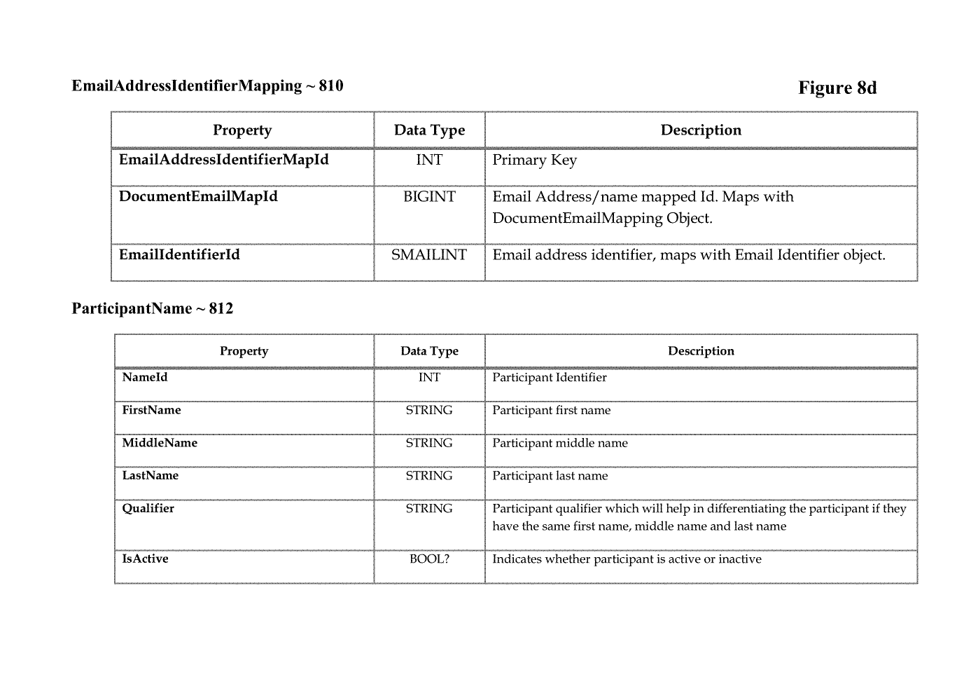

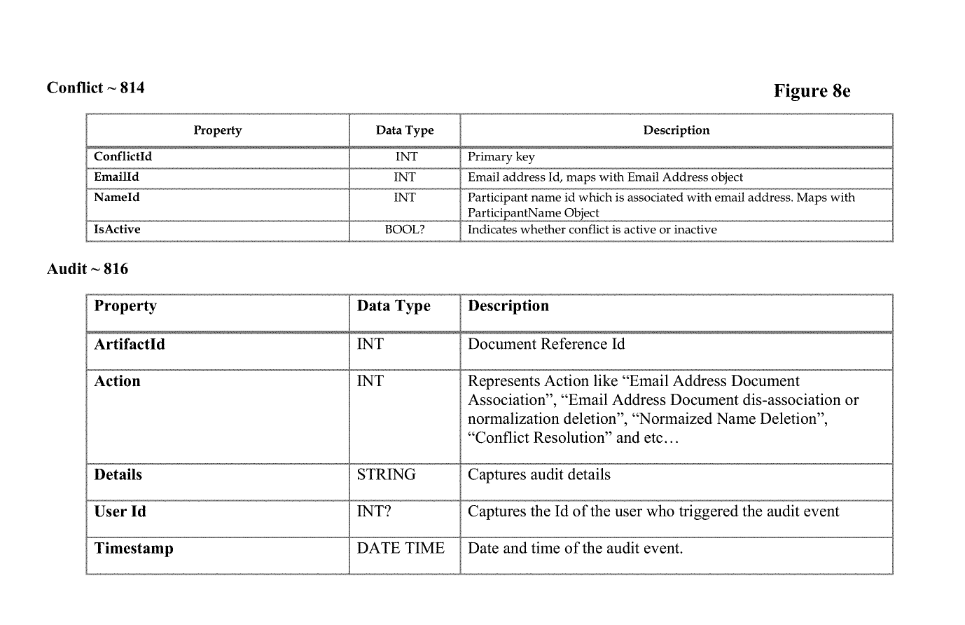

Process 700 may start at block 702. At block 702, a determination may be made on whether the names and/or email addresses being processed are extracted from electronic documents (edoc) subject to at least partial privileged protection, or being imported. If a result of the determination at block 702 indicates that the names and/or email addresses being processed are extracted from electronic documents subject to at least partial privileged protection, at block 704, a further determination may be made on whether the author names and/or email addresses being processed are extracted from email or electronic word documents. If a result of the determination at block 704 indicates that the author names and/or email addresses being processed are extracted from emails, at block 706, author names/email fields normalization operations may be performed. However, if a result of the determination at block 704 indicates that the names and/or email addresses being processed are extracted from email documents, at block 708, email body thread participants normalization operations may be performed. Back at block 702, if a result of the determination at block 704 indicates that the names and/or email addresses being processed are being imported, at block 710, import list normalization operations may be performed. Email fields normalization operations (at block 706), document body thread participants normalization operations (at 708), and import list normalization operations (at 710) will be further described below with references to FIGS. 8a-8e, 9a-9c, 10a-10c and 11a-11c.

Continuing to refer to FIG. 7, on performance of either email fields normalization operations (at block 706), document body thread participants normalization operations (at 708), or import list normalization operations (at 710), process 700 may proceed to block 712. At block 712, a determination may be made on whether there are conflicts among the name and email address mappings, e.g., whether an email address is mapped to more than one name. On determining the existence of conflicts, operations at blocks 714 and 716 may be performed. At blocks 714 and 716, UI tabs 600a and 600b may be used to display the conflicting names and email addresses for a user to resolve. On completion of the operations at blocks 714 and 716, process 700 may return to block 712, and continue therefrom. In embodiments, some amount of auto normalization may be performed. For example, if email addresses E1, E2 are normalized to names N1, N2 respectively for document D1. At a later point in time, if the function identifies a similar email address E2 as part of Document D2, then E2 in D2 may be automatically normalized to N2 without asking for user intervention. In still other embodiments, normalization may also include predicting the first name, middle name and last name of the associated name, based at least in part on a discovered email address, if no name is identified or known as associated with the discovered email address.

Eventually, a result of the determination at block 712 would indicate all conflicts have been resolved. At such time, process 700 may proceed to block 718, where the normalized names and email addresses may be stored. Next, at block 720, UI tabs 600c an/or 600d may be used to display the normalized names and email addresses.

FIGS. 8a-8d collectively illustrate various example data objects suitable for use to implement the name-email normalization function FIG. 1 (or FIG. 5) or practice the process of name-email normalization of FIG. 7. As shown, these data objects may include:

a) ToSaveTempDocumentEmail 802

b) DocumentDetail 804

c) EmailAddress 806

d) Email Identifier (Master) 807

e) DocumentEmailMapping 808

f) Email Source (Master) 809

g) EmailAddressIdentifierMapping 810

h) ParticipantName 812

i) Conflict 814

j) Audit 816

ToSaveTempDocumentEmail 802 may be used as a container to hold records fetch from a document object of eDiscovery application 114. ToSaveTempDocumentEmail 802 may include data elements, such as EmailBCC, EmailCC, EmailFrom, EmailTo, AUTHOR, and so forth, to respectively hold BCC email participant, CC email participant, From email participant, To email participant, author of an electronic word document, and so forth.

DocumentDetail 804 may be used to contain information of a document object of eDiscovery application 114. DocumentDetail 804 may include data elements such as DocumentId and ReviewID to respectively hold a unique identifier for a document, and an identifier of the privilege determination reviewer. DocumentDetail 804 may include IsDocumentStatusChanged, IsLowerEmailParticipantsProcessedIsActive, ConversationBlockCount, and IsEmailDocument to respectively hold a document changed status indicator, an indicator to denote whether the email body thread participants are processed or not, an indicator to denote the count of processed email conversation blocks from email body, and an indicator to denote whether the processed document is an email or non-email type of document.

EmailAddress 806 may be used to contain email information along with participant. EmailAddress 806 may include data elements, such as EmailID, Email Address, ParticipantNameId, EmailPartId, Email SourceID, ISExternalEmailParticpant, IsHeaderEmailParticipant, and IsLowerEmailParticpant to respectively hold a primary key, an email address, a mapped email participant identifier (which may indicate whether it is from document metadata, document body or from external list), an indicator to denote whether the email address is added through import, an indicator to denote whether the email address is pulled from metadata fields of the document object, and indicator to denote whether the email address is pulled from email body thread participants. EmailAddress 806 may further include data elements, such as NameId and IsActive to respectively hold a name normalization object participant identifier, and an indicator to denote whether this email address is active or inactive.

EmailPart (Master) 807 may be used for identifying email parts. EmailPart (Master) 807 may include data elements such as EmailPartID and EmailPart to respectively hold a primary key and an indicator denoting whether the email part is a header or a lower part (body).

DocumentEmailMapping 808 may be used for marking relationship between document objects of eDiscovery application 114 and Email Address 806. DocumentEmailMapping 808 may include data elements, such as DocumentEmailMapId, DocumentDetailIsId, and EmailId to respectively hold a primary key, a document detail identifier, and a participant email address identifier associated with an email address.

EmailSource (Master) 809 may be used for identifying email sources. EmailSource (Master) 809 may include data elements such as EmailSourceID and Source to respectively hold a primary key and an indicator denoting a source type, e.g., “meta data,” “lower email participants,” “external list” and so forth.

EmailAddressIdentifierMapping 810 may be used to map document email address with identifier types. EmailAddressIdentifierMapping 810 may data elements, such as EmailAddressIdentifierMapId, DocumentEmailMapId, and EmailIdentifierId to respectively hold a primary key, Document Email Address Mapping Id, and an email address identifier.

ParticipantName 812 may be used to contain information related to participant name. ParticipantName 812 may include data elements, such as NameId, FirstName, MiddleName, LastName, Qualifier, and IsActive to hold a participant identifier, a participant first name, a participant middle name, a participant last name, a participant's name qualifier, and an indicator to denote whether a participant is active or inactive.

Conflict 814 may be used to maintain the status of name and/or email conflict occurrences. Conflict 814 may include data elements, such as ConflictId, EmailId, NameId, and IsActive to respectively hold a primary key, an email address identifier (maps with EmailAddress object), a participant name identifier which is associated with email address (maps with ParticipatntName Object), and an indicator to denote whether conflicts are active or inactive.

Audit 814 may be used to hold auditing information. Conflict 814 may include data elements, such as ArtifactId, Action, Detail, User Id and Timestamp to respectively hold a document reference identifier, an indicator denoting a type of action (such as, Email Address Document Association“, “Email Address Document dis-association or normalization deletion”, “Normaized Name Deletion”, “Conflict Resolution” and so forth, audit details, identifier of the user who triggered the audit event, and data and time of the audit event.

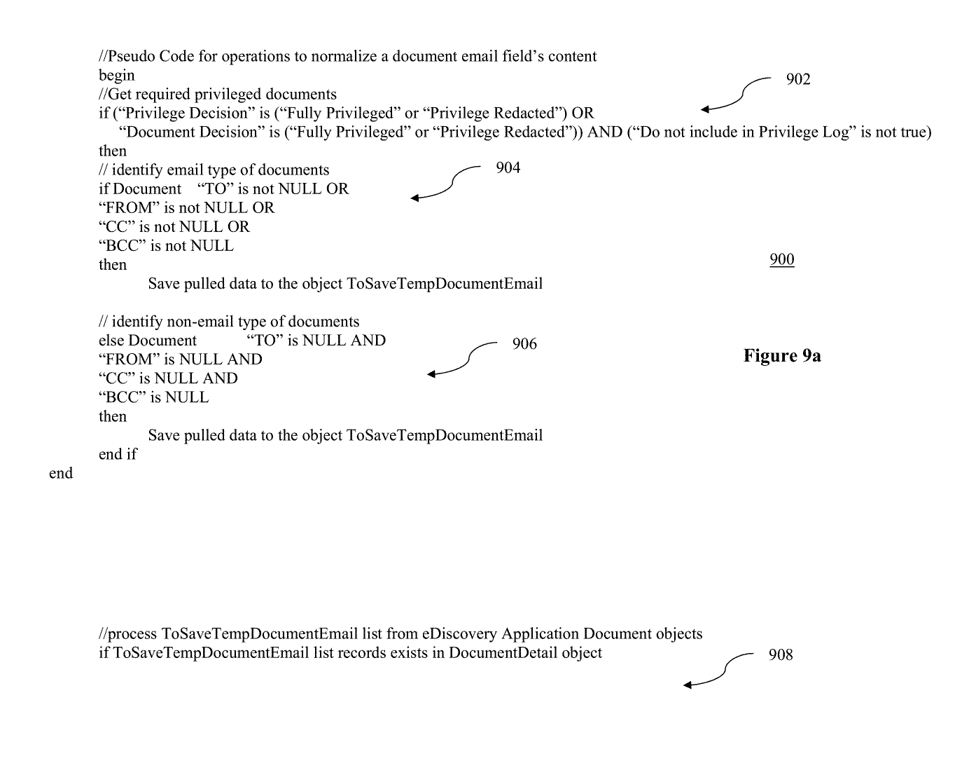

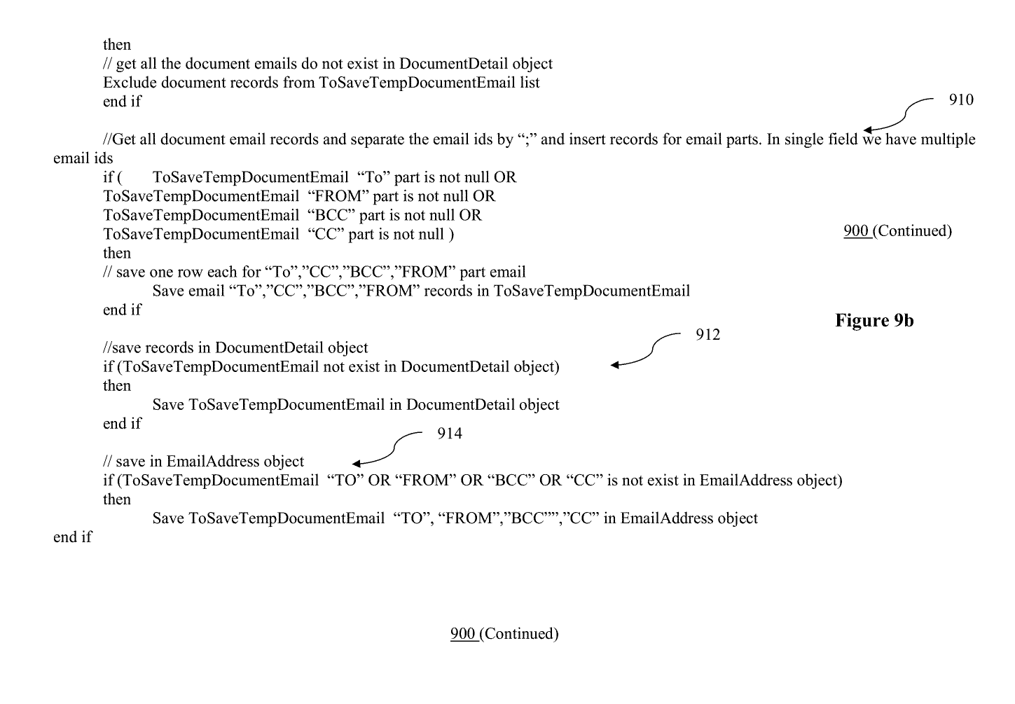

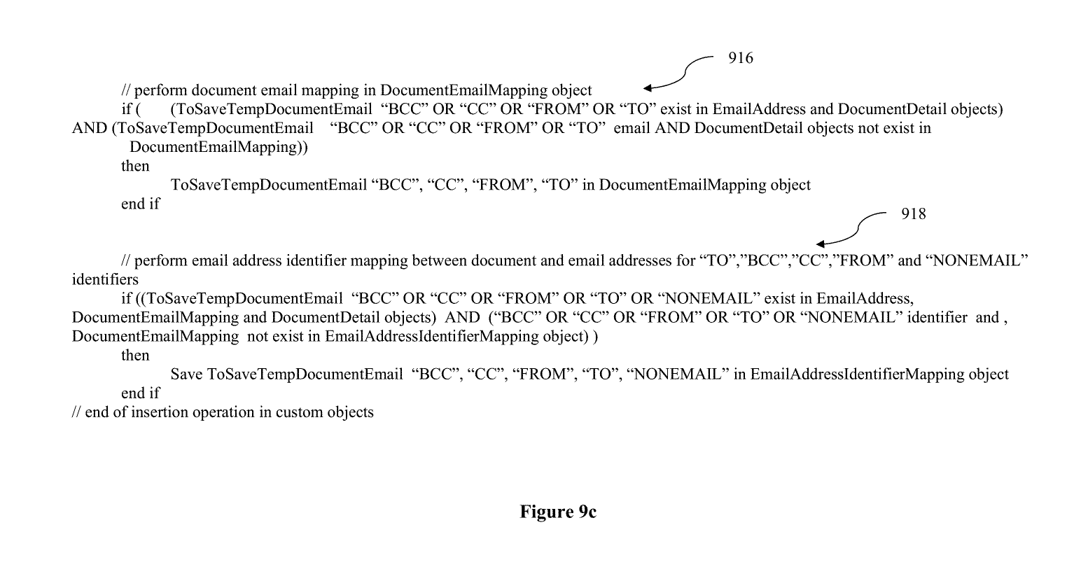

FIGS. 9a-9c collectively illustrate example pseudo code for the logic flow of the email field normalization operations of FIG. 7. As shown in FIG. 9a, logic flow 900 may include operations 902 to get required privilege documents, operations 904 to identify email type documents, and operation 906 to identify non-email type documents (such as electronic word documents). Additionally, as shown in FIG. 9b, logic flow 900 may further include operations 908 to process the earlier described ToSaveTempDocumentEmail data object, operations 910 to get all document email records and separate the email ids by “;” and insert records for email parts, operations 912 to save records in the earlier described DocumentDetail object, and operations 914 to save data into the earlier described EmailAddress data object. Further, as shown in FIG. 9c, logic flow 900 may also include operations 916 to perform document email mapping in the earlier described DocumentEmailMapping data object, and operations 918 to perform email address identifier mapping between document and email addresses for “TO”, “BCC”, “CC”, “FROM” and “NONEMAIL” identifiers.

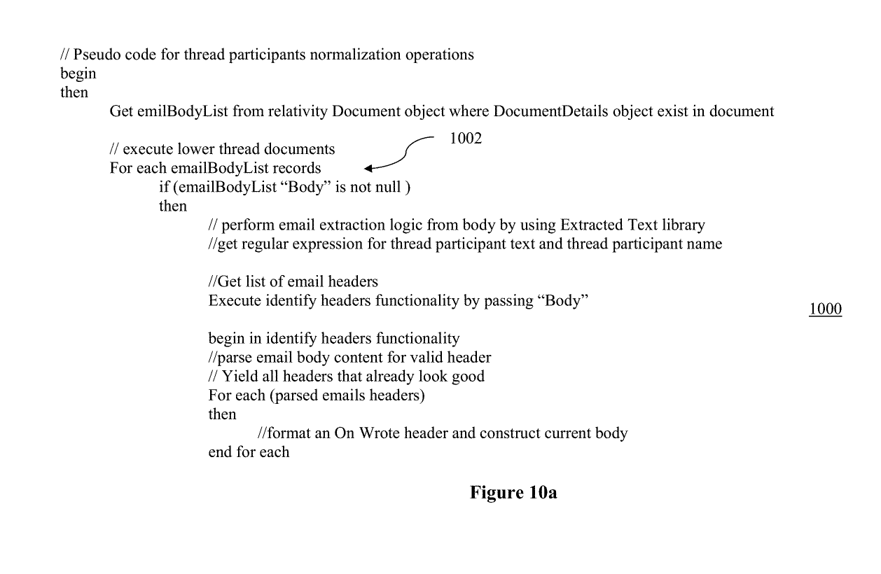

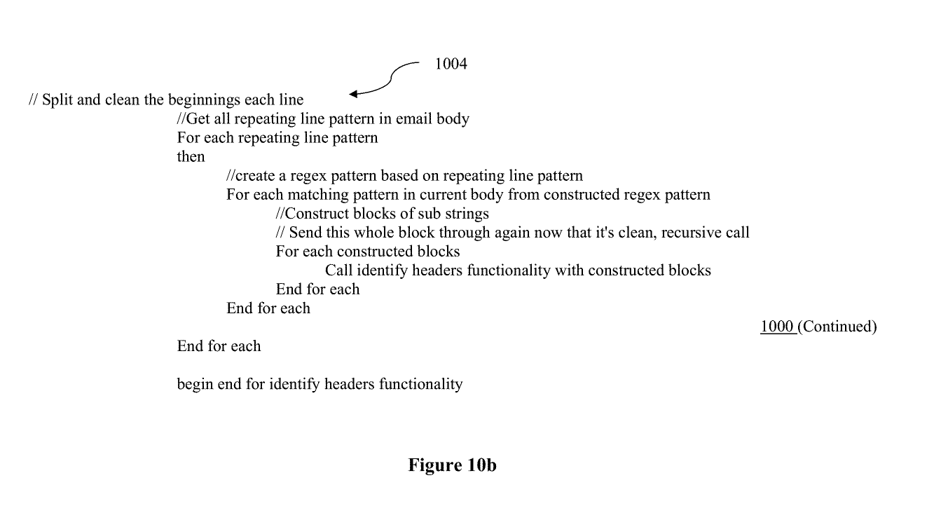

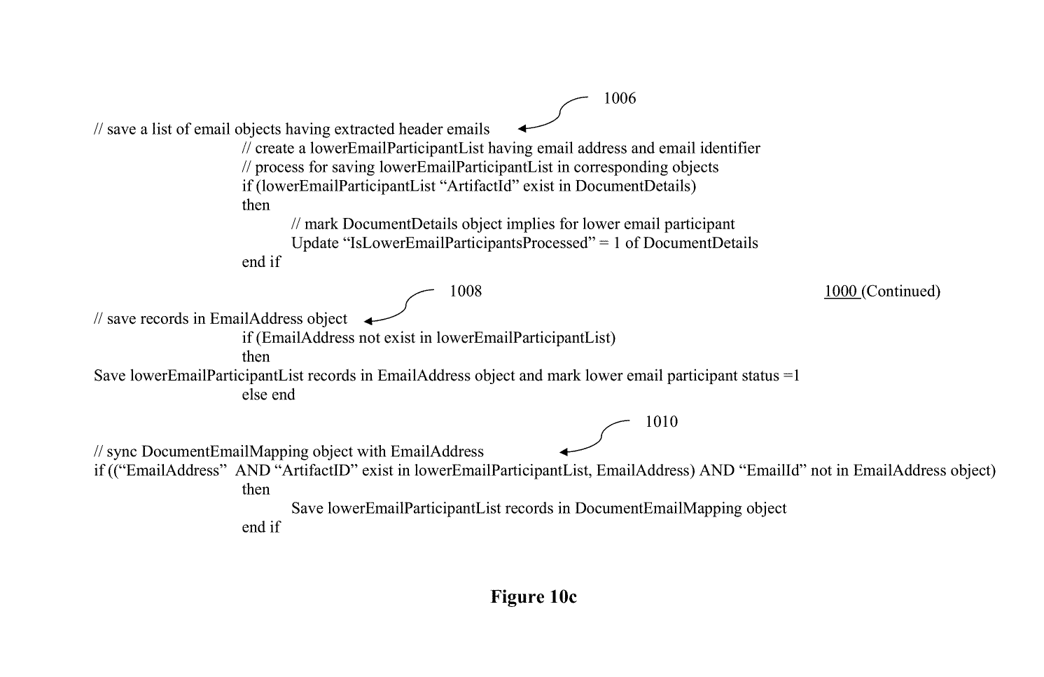

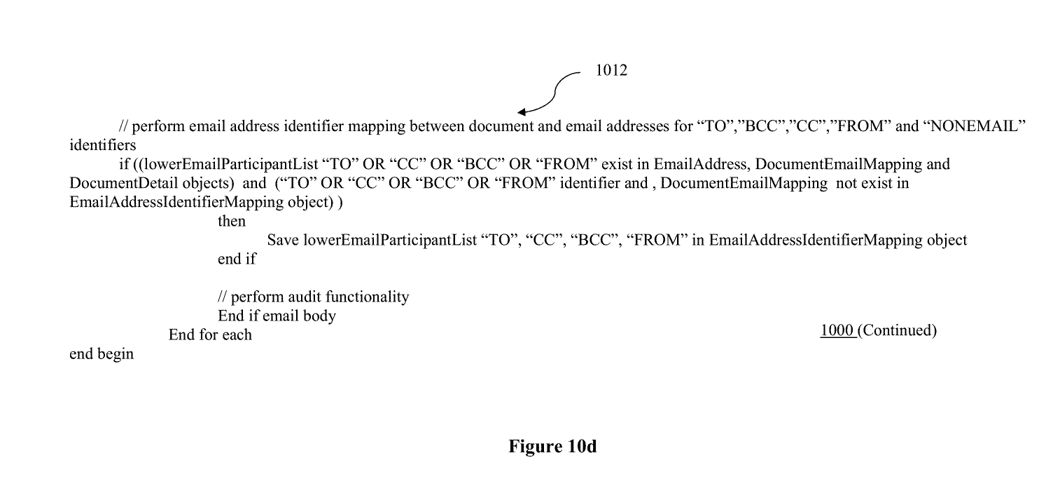

FIGS. 10a-10d collectively illustrate example pseudo code for the logic flow of the document thread participant normalization operations of FIG. 7. As shown in FIGS. 10a-10b, logic flow 1000 may include operations 1002 to process lower thread documents, and operations 1004 to split and clean the beginning of each line. As shown in FIG. 10c, logic flow 1000 may further include operations 1006 to save a list of email objects having extracted header emails, operations 1008 to save records in the earlier described EmailAddress data object, and operation 1010 to sync the earlier described DocumentEmailMapping data object with the earlier described EmailAddress data object. As shown in FIG. 10d, logic flow 1000 may further include operations 1012 to perform email address identifier mapping between document and email addresses for “TO”, “BCC”, “CC”, “FROM” and “NONEMAIL” identifiers.

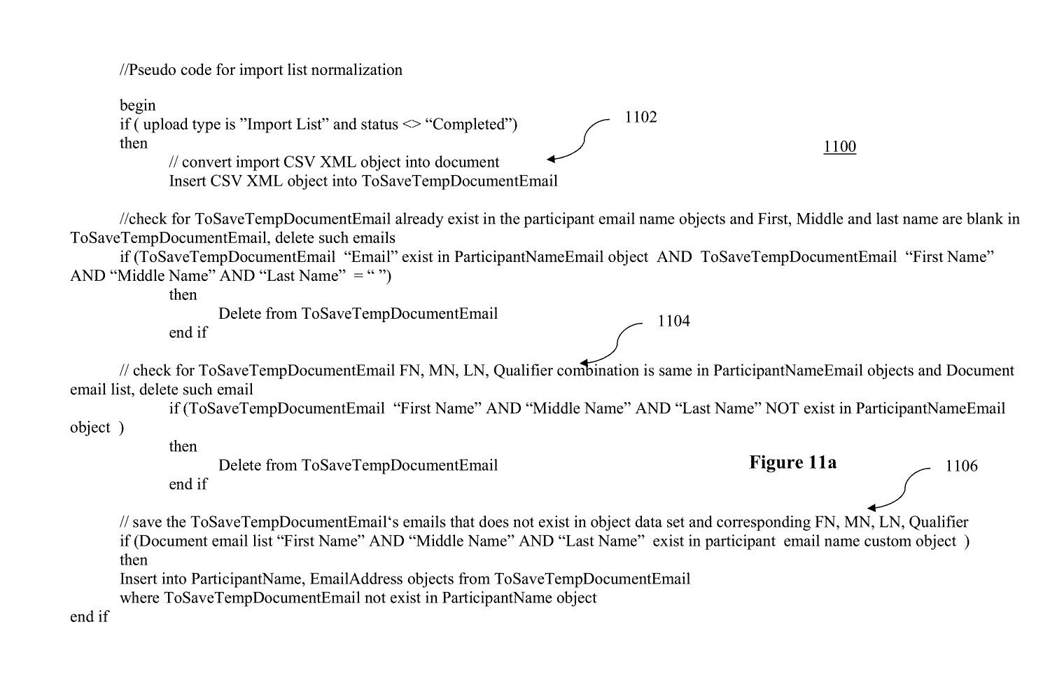

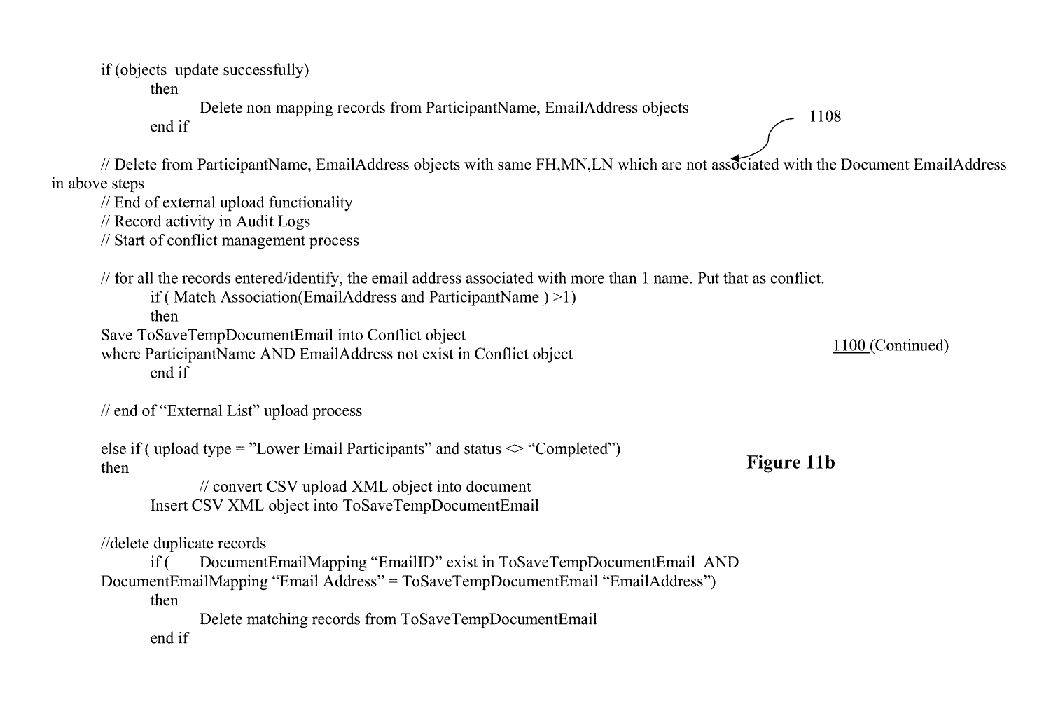

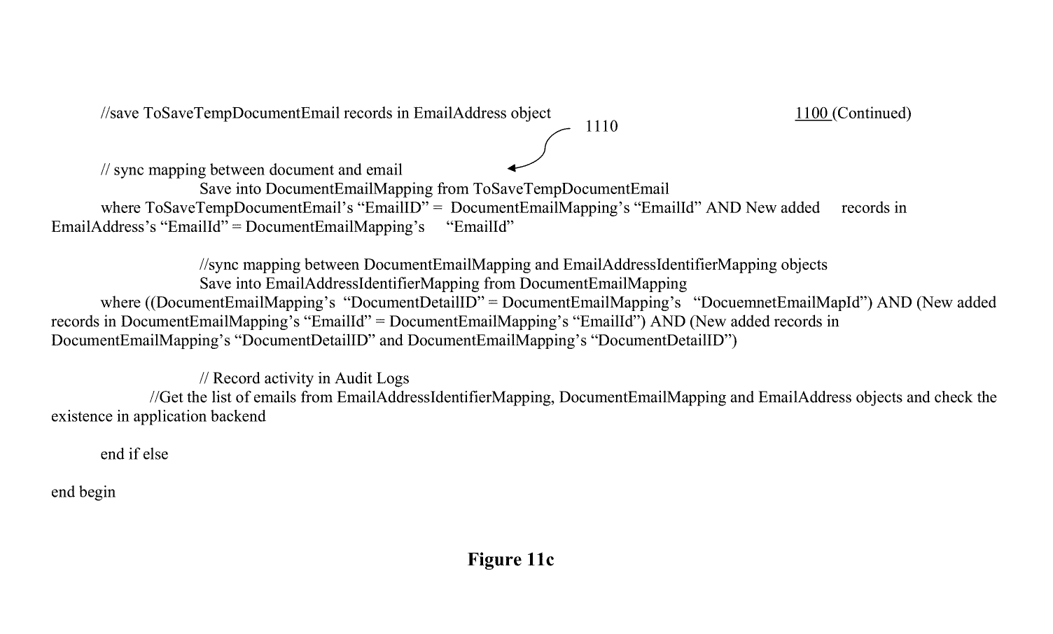

FIGS. 11a-11c collectively illustrate example pseudo code for the logic flow of the import list normalization operations of FIG. 7. As shown in FIG. 11a, logic flow 1100 for import list normalization may include operations 1012 to import the data from the import file (e.g., a CSV file) into the document objects. Logic flow 1100 may further include operations 1104 to check for whether a first name, middle name, last name, and qualifier combination in the earlier described ToSaveTempDocumentEmail data object is the same as in the earlier described ParticipantNameEmail data objects and Document email list, if so, delete such email. Logic flow 1100 may also include operations 1106 save the ToSaveTempDocumentEmail's emails that does not exist in object data set and the corresponding first name, middle name, last name, and qualifier combination.

As shown in FIG. 11b, logic flow 1100 may further include operations 1108 to delete from the earlier described ParticipantName and EmailAddress data objects with same first name, middle name, last name, and qualifier combination, which are not associated with the document EmailAddress in the earlier operations. As shown in FIG. 11c, logic flow 1100 may further include operations 1110 to synchronize mapping between document and email.

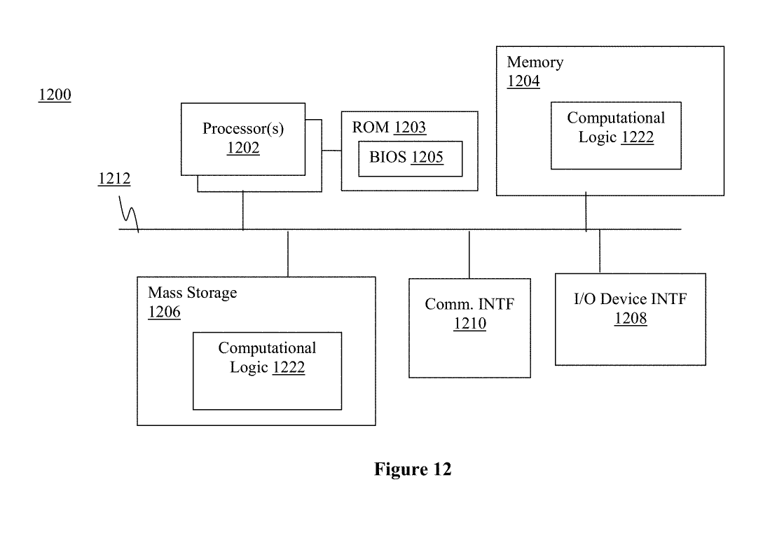

FIG. 12 illustrates an example computing device that may be suitable for use to practice selected aspects of the present disclosure. As shown, computer device 1200 may include one or more processors or processor cores 1202, read-only memory (ROM) 1203, and system memory 1204. Additionally, computing device 1200 may include mass storage devices 1206. Example of mass storage devices 1206 may include, but are not limited to, tape drives, hard drives, compact disc read-only memory (CD-ROM) and so forth). Further, computer device 1200 may include input/output devices 1208 (such as display, keyboard, cursor control and so forth) and communication interfaces 1210 (such as network interface cards, modems and so forth). The elements may be coupled to each other via system bus 1212, which may represent one or more buses. In the case of multiple buses, they may be bridged by one or more bus bridges (not shown).

Each of these elements may perform its conventional functions known in the art. In particular, ROM 1203 may include basic input/output system services (BIOS) 1205. System memory 1204 and mass storage devices 1206 may be employed to store a working copy and a permanent copy of the programming instructions implementing the operations associated with privilege log generator 116, in particular, auto privilege description generation function 122 and name-email normalization function 124, as earlier described, collectively referred to as computational logic 1222. The various elements may be implemented by assembler instructions supported by processor(s) 1202 or high-level languages, such as, for example, C, that can be compiled into such instructions.

The number, capability and/or capacity of these elements 1210-1212 may vary, depending on whether computing device 1200 is used as a mobile device, such as a wearable device, a smartphone, a computer tablet, a laptop and so forth, or a stationary device, such as a desktop computer, a server, a game console, a set-top box, an infotainment console, and so forth. Otherwise, the constitutions of elements 1210-1212 are known, and accordingly will not be further described.

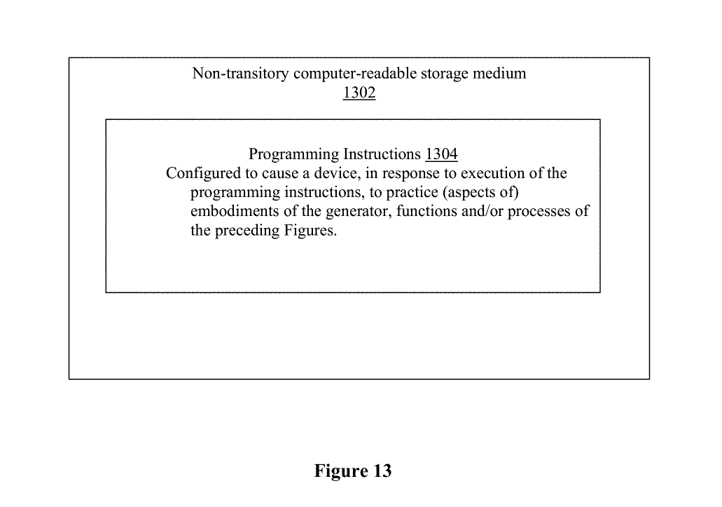

FIG. 13 illustrates an example non-transitory computer-readable storage medium having instructions configured to practice all or selected ones of the operations associated with privilege log generator 116, in particular, auto privilege description generation function 122 and name-email normalization function 124, and so forth, earlier described, in accordance with various embodiments. As illustrated, non-transitory computer-readable storage medium 1302 may include a number of programming instructions 1304. Programming instructions 1304 may be configured to enable a device, e.g., computer device 1200, in response to execution of the programming instructions, to perform, e.g., various privilege log generator 116, in particular, auto privilege description generation function 122 and name-email normalization function 124 operations, as earlier described. In alternate embodiments, programming instructions 1304 may be disposed on multiple non-transitory computer-readable storage media 1302 instead. In still other embodiments, programming instructions 1304 may be encoded in transitory computer readable signals.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for electronically producing documents for a discovery request, comprising:
one or more processors; and
a privilege log generator to be operated by the one or more processors to generate a privilege log for a plurality of electronic documents to be produced for a discovery request, wherein at least a subset of the plurality of electronic documents are at least partially privilege protected;
wherein the privilege log generator includes a name-email normalization function to provide assistance in normalization of names or email addresses contained in the electronic documents for the privilege log.

2. The apparatus of claim 1, wherein the name-email normalization function includes a sub-function to normalize names or email addresses contained in electronic mails.

3. The apparatus of claim 1, wherein the name-email normalization function includes a sub-function to normalize names or email addresses contained in electronic word documents.

4. The apparatus of claim 1, wherein the name-email normalization function includes a sub-function to normalize names or email addresses of an import list.

5. The apparatus of claim 1, wherein the name-email normalization function includes a user interface that includes a name normalization tab used to display the names and emails extracted from documents subject to at least partial privilege protection, and names of participants, and a conflict management tab used to resolve name or email address conflicts.

6. The apparatus of claim 5, wherein the user interface further includes a normalized data management tab used for review and for removal of mapped associations, and a name normalization report tab used to display read-only the normalized name and email address mappings.

7. The apparatus of claim 1, wherein the name-email normalization function includes one or more data objects, including a Conflict data object used to maintain status of name or email conflict occurrences.

8. The apparatus of claim 7, wherein the one or more data objects further include a ToSaveTempDocumentEmail data object used as a container to hold records fetch from a document object of an electronic discovery application, a DocumentDetail data object used to contain information of the document object of the electronic discovery application, and a DocumentEmailMapping data object used for marking relationship between document objects of the electronic discovery application.

9. The apparatus of claim 7, wherein the one or more data objects further include an EmailAddress data object used to contain email information along with participant, and associated conflict, an EmailAddressIdentifierMapping data object used to map email address with identifier types, and an ParticipantName data object used to contain information related to participant name and maintain relationship between name conflicts with email address.

10. The apparatus of claim 1, wherein the name-email normalization function automatically normalize an email address E to a name N when processing an electronic document D2, if the email address E has been previously normalized to name N in earlier processing of another electronic document D1.

11. The apparatus of claim 1, wherein the name-email normalization function automatically predicts a name based at least in part on a discovered email address in an electronic document, if no known name is associated with discovered email address.

12. The apparatus of claim 1, wherein the privilege log generator further includes an auto privilege description generation function to semi-automatically generate a standardized description for an entry in the privilege log.

13. The apparatus of claim 12, wherein the auto privilege description generation function is to display a user interface with a plurality of input-fields to collect inputs for a plurality of portions of the standardized description for an entry in the privilege log, and to automatically generate the standardized description for the entry in the privilege log using the inputs collected.

14. The apparatus of claim 1, wherein the privilege log generator is to further retrieve the subset of electronic documents that are at least partially privilege protected from an eDiscovery application, through an application programming interface or web services of the eDiscovery application.

15. A method for electronically producing documents for a discovery request, comprising:
receiving, by a privilege log generator operated on a computing device, a plurality of electronic documents to be produced for a discovery request, wherein the plurality of electronic documents are at least partially privilege protected; and
generating, by the privilege log generator, a privilege log listing the plurality of electronic documents, wherein generating the privilege log includes automatic or semi-automatic normalizing of names or email addresses contained in the plurality of electronic documents.

16. The method of claim 15, wherein automatic or semi-automatic normalizing of names or email addresses contained in the plurality of electronic documents includes normalizing of names or email addresses contained in electronic mails.

17. The method of claim 15, wherein automatic or semi-automatic normalizing of names or email addresses contained in the plurality of electronic documents includes normalizing of names or email addresses contained in electronic word documents.

18. The method of claim 15, wherein automatic or semi-automatic normalizing of names or email addresses contained in the plurality of electronic documents includes normalizing of names or email addresses of an import list.

19. The method of claim 15, wherein automatic or semi-automatic normalizing of names or email addresses contained in the plurality of electronic documents includes displaying a user interface that includes a name normalization tab used to display the names and emails extracted from documents subject to at least partial privilege protection, and names of participants, and a conflict management tab used to resolve name or email address conflicts.

20. The method of claim 19, wherein automatic or semi-automatic normalizing of names or email addresses contained in the plurality of electronic documents includes displaying a normalized data management tab used for review and for removal of mapped associations, and a name normalization report tab used to display read-only the normalized name and email address mappings.

21. The method of claim 15, wherein automatic or semi-automatic normalizing of names or email addresses contained in the plurality of electronic documents includes automatically normalizing an email address E to a name N when processing an electronic document D2, if the email address E has been previously normalized to name N in earlier processing of another electronic document D1.

22. The method of claim 15, wherein automatic or semi-automatic normalizing of names or email addresses contained in the plurality of electronic documents includes automatically predicting a name based at least in part on a discovered email address in an electronic document, if no known name is associated with discovered email address.

23. The method of claim 15, further comprising semi-automatically generating a standardized description for an entry in the privilege log.

24. The method of claim 23, wherein semi-automatically generating a standardized description for an entry in the privilege log comprises displaying a user interface with a plurality of input-fields to collect inputs for a plurality of portions of the standardized description for an entry in the privilege log, and automatically generating the standardized description for the entry in the privilege log using the inputs collected.

25. One or more non-transitory computer-readable storage medium having a plurality of instructions to cause an apparatus, in response to execution of the instructions by the apparatus, to implement a privilege log generator to:
receive a plurality of electronic documents to be produced for a discovery request, wherein the plurality of electronic documents are at least partially privilege protected; and
generate a privilege log listing the plurality of electronic documents, wherein generation of the privilege log includes automatic or semi-automatic normalization of names or email addresses contained in the plurality of electronic documents; and semi-automatic generation of a standardized description for an entry in the privilege log.
